(19) United States
(12) Patent Application Publication
(10) Pub. No.: US 2025/0358675 A1
(43) Pub. Date: Nov. 20, 2025

(54) HANDLING PACKET LOSSES FOR CONGESTION CONTROL AND APPLICATION-LAYER FEC

(71) Applicant: QUALCOMM Incorporated, San Diego, CA (US)

(72) Inventors: Liangping MA, San Diego, CA (US); Imed BOUAZIZI, Celina, TX (US); Sitaramanjaneyulu KANAMARLAPUDI, San Diego, CA (US); Prashanth Haridas HANDE, San Diego, CA (US); Sebastian SPEICHER, Wallisellen (CH); Hyun Yong LEE, San Diego, CA (US); Yih-Hao LIN, San Diego, CA (US); Thomas STOCKHAMMER, Bergen (DE)

(21) Appl. No.: 19/207,279

(22) Filed: May 13, 2025

Related U.S. Application Data
(60) Provisional application No. 63/647,563, filed on May 14, 2024.

(51) Int. Cl. H04W 28/02

(52) U.S. Cl. CPC H04W 28/0289; H04W 28/0284

(57) ABSTRACT

Apparatus, methods, and computer program products for wireless communication are provided. An example method may include transmitting an indication of a congestion state associated with the network entity. The example method may further include refraining from transmitting at least one obsolete packet for an application endpoint based on the congestion state being uncongested or refrain from transmitting at least one packet for the application endpoint based on the congestion state being congested.

### CROSS REFERENCE TO RELATED APPLICATION(S)

This application claims the benefit of and priority to Provisional Application Ser. No. 63/647,563, entitled “HANDLING PACKET LOSSES FOR CONGESTION CONTROL AND APPLICATION-LAYER FEC” and filed on May 14, 2024, which is expressly incorporated by reference herein in its entirety.

### TECHNICAL FIELD

The present disclosure relates generally to communication systems, and more particularly, to wireless communication systems with application layer error correction.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a network entity are provided. The apparatus may include at least one memory and at least one processor coupled to the at least one memory. Based at least in part on information stored in the at least one memory, the at least one processor, individually or in any combination, is configured to transmit an indication of a congestion state associated with the network entity. Based at least in part on information stored in the at least one memory, the at least one processor, individually or in any combination, is configured to refrain from transmitting at least one obsolete packet for an application endpoint based on the congestion state being uncongested or refrain from transmitting at least one packet for the application endpoint based on the congestion state being congested.

In another aspect of the disclosure, a method, a computer-readable medium, and an apparatus at an application sender are provided. The apparatus may include at least one memory and at least one processor coupled to the at least one memory. Based at least in part on information stored in the at least one memory, the at least one processor, individually or in any combination, is configured to (e.g., cause the application sender to) receive, from a network entity, an indication of a congestion state associated with the network entity. Based at least in part on information stored in the at least one memory, the at least one processor, individually or in any combination, is configured to adjust a sending rate based on a packet loss rate, the packet loss rate being a current packet loss rate based on the congestion state being uncongested or the packet loss rate being a previous packet loss rate based on the congestion state being congested.

In another aspect of the disclosure, a method, a computer-readable medium, and an apparatus at an application sender are provided. The apparatus may include at least one memory and at least one processor coupled to the at least one memory. Based at least in part on information stored in the at least one memory, the at least one processor, individually or in any combination, is configured to (e.g., cause the application sender to) receive, from an application receiver, an application data unit (ADU) loss rate and at least one of a packet loss rate, a queueing delay, or an explicit congestion notification (ECN) marking. Based at least in part on information stored in the at least one memory, the at least one processor, individually or in any combination, is configured to adjust a sending rate based on the ADU loss rate and at least one of the packet loss rate, the queueing delay, or the ECN marking.

In another aspect of the disclosure, a method, a computer-readable medium, and an apparatus at an application receiver are provided. The apparatus may include at least one memory and at least one processor coupled to the at least one memory. Based at least in part on information stored in the at least one memory, the at least one processor, individually or in any combination, is configured to (e.g., cause the application receiver to) establish a connection with an application sender. Based at least in part on information stored in the at least one memory, the at least one processor, individually or in any combination, is configured to transmit, to the application sender, an indication of at least one loss rate.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating example communications between an application sender, a network entity, and an application receiver.

FIG. 5 is a diagram illustrating example a communication flow between an application sender, a network entity, and an application receiver.

FIG. 6 is a flowchart of a method of wireless communication.

FIG. 7 is a flowchart of a method of wireless communication.

FIG. 8 is a flowchart of a method of wireless communication.

FIG. 9 is a flowchart of a method of wireless communication.

FIG. 10 is a diagram illustrating an example of a hardware implementation for an example apparatus and/or network entity, in accordance with various aspects of the present disclosure.

FIG. 11 is a diagram illustrating an example of a hardware implementation for an example network entity, in accordance with various aspects of the present disclosure.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof. One or more processors in the processing system may execute software to cause a device that includes the one or more processors to perform the various functionality described throughout this disclosure.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer (e.g., transitory or non-transitory medium that may be accessed by computer).

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

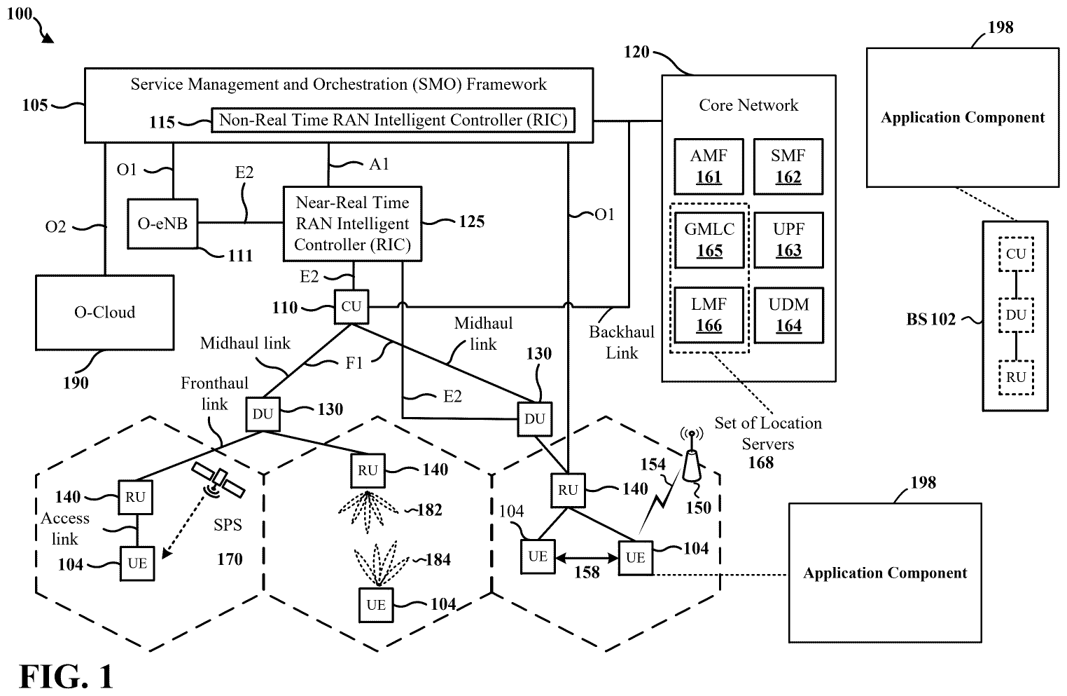

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 or the base station 102 may include an application component 198. In some aspects, the application component 198 may be configured to transmit an indication of a congestion state associated with the network entity. In some aspects, the application component 198 may be further configured to refrain from transmitting at least one obsolete packet for an application endpoint based on the congestion state being uncongested or refrain from transmitting at least one packet for the application endpoint based on the congestion state being congested.

In some aspects, the application component 198 may be configured to establish a connection with an application sender. In some aspects, the application component 198 may be further configured to transmit, to the application sender, an indication of at least one loss rate.

In some aspects, the application component 198 may be configured to receive, from a network entity, an indication of a congestion state associated with the network entity. In some aspects, the application component 198 may be further configured to adjust a sending rate based on a packet loss rate, the packet loss rate being a current packet loss rate based on the congestion state being uncongested or the packet loss rate being a previous packet loss rate based on the congestion state being congested.

In some aspects, the application component 198 may be configured to receive, from an application receiver, an application data unit (ADU) loss rate and at least one of a packet loss rate, a queueing delay, or an ECN marking. In some aspects, the application component 198 may be further configured to adjust a sending rate based on the ADU loss rate and at least one of the packet loss rate, the queueing delay, or the ECN marking.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

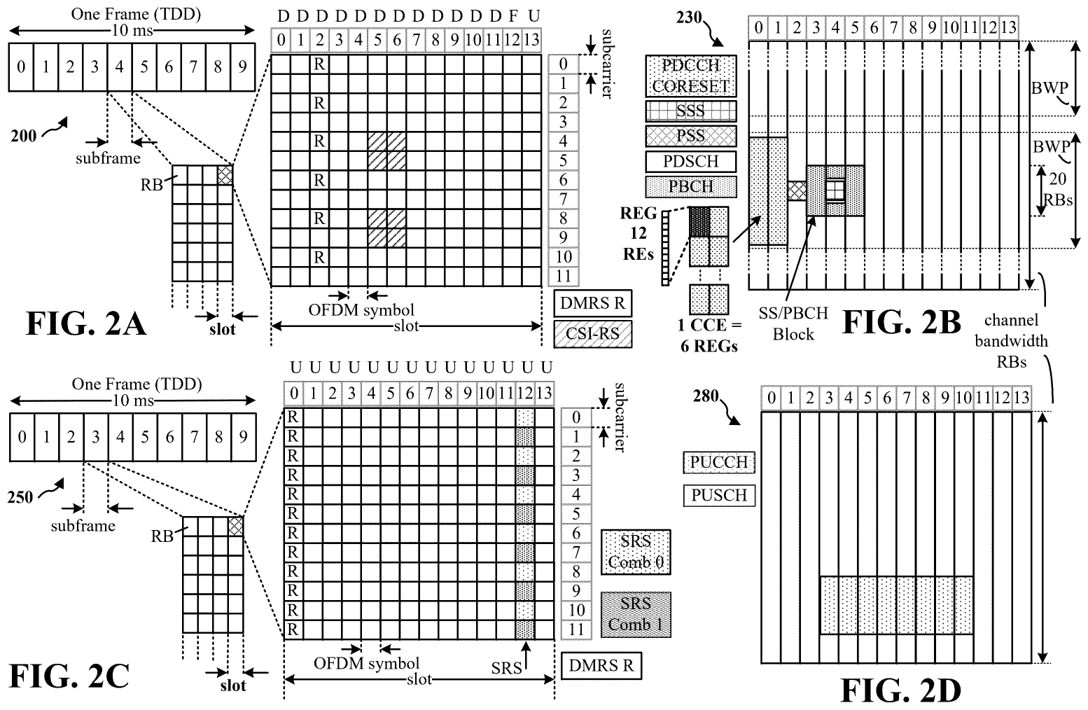

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 24*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

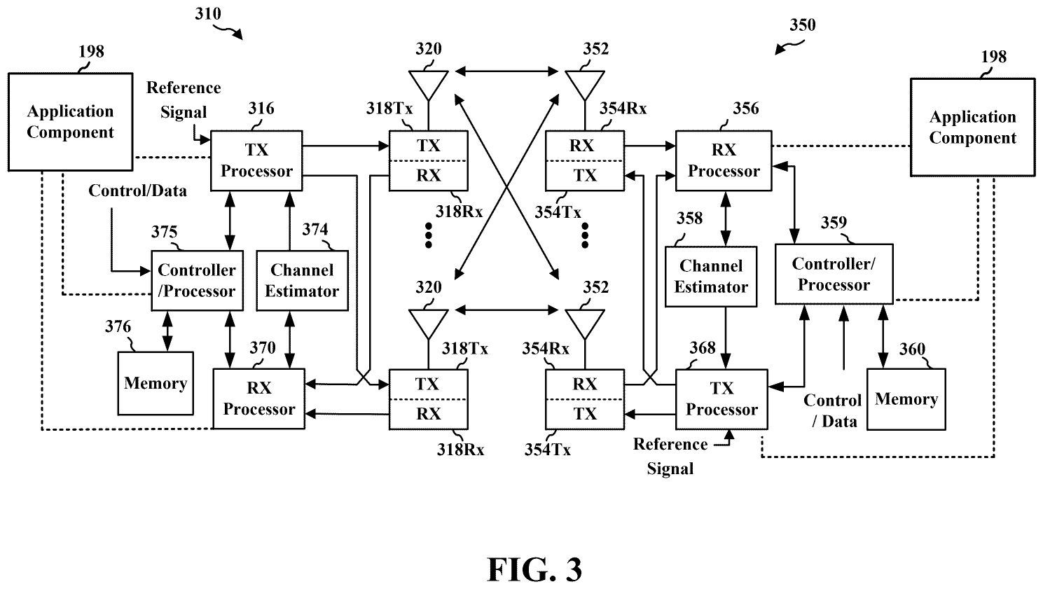

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with application component 198 of FIG. 1.

At least one of the TX processor 316, the RX processor 370, and the controller/processor 375 may be configured to perform aspects in connection with application component 198 of FIG. 1.

In some real-time communication systems, application layer (AL) forward error correction (FEC) may be used. For example, flexible FEC (FlexFEC) or uneven level protection FEC (ULPFEC) may be used in Web real-time communication (WebRTC) implementation and Reed-Solomon code FEC may be used in some messenger systems. There may also be usage of Raptor codes FEC in low-latency immersive and gaming applications. A network entity may intentionally drop obsolete packets (e.g., obsolete repair packets in the case of FlexFEC, obsolete coded packets in Reed-Solomon codes, or the like) to save UE's power (so that the UE does not stay awake longer to receive the obsolete packets). In some aspect, a packet is considered obsolete if it is not used (e.g., not needed) anymore for reconstructing the ADU carried by a PDU set. In some aspects, intentionally dropping obsolete packets means that the network drops more packets than what is specified by a policy to reduce network congestion. In some example, the policy may be realized by an active queue management algorithm. Congestion control regulates the sending rate that the application can inject into the communication system. Packet losses may be interpreted as a signal of network congestion. On detecting a packet loss, the application sender may reduce the sending rate. Queueing delays may be also interpreted as a signal of network congestion. However, intentionally dropping obsolete packets may affect the queueing delay or the packet loss. Therefore, the application sender may reduce the sending rate even if obsolete packets are intentionally dropped.

In other words, intentionally dropping obsolete packets may negatively affect congestion control, resulting in lower sending rate. There may also be congestion caused packet drops, to which the application sender may react. In some wireless communication systems, an application sender may not know whether a packet drop is due to intentional dropping or congestion caused dropping, causing potential inefficiency.

As used herein, the term “application sender” or the term “application sender endpoint” may refer to an entity, such as a network entity, an application server, a UE, or the like, that may utilize UL, DL, or sidelink communication to transmit application layer data to an “application receiver” or an “application receiver endpoint.” The application receiver may be an intended receiver of the application layer data. The application receiver may also be a UE, a network entity, an application server, or the like. The application endpoint may transmit application layer data back to the application sender and may also provide feedback on packet loss information (e.g., packet loss rate), application data unit (ADU) loss information (e.g., ADU loss rate), or other information. As used herein, the term “application endpoint” may refer to one of the application sender or the application receiver.

Aspects provided herein may enable an application sender to be able to adjust sending rates more efficiently such that the application may be able to adjust sending rates differently depending on whether packet dropping is due to intentional dropping or congestion caused dropping.

There are two causes that the network drops packets: (1) intentionally dropping obsolete packets and (2) dropping due to network congestion. After observing a packet loss, the application may not know the cause, hence ambiguity on the state of the network (i.e., congested or not). In some aspects, the network may intentionally drop packets when the network is not in congestion and may not be allowed to intentionally drop packets when the network is in congestion. In some aspects, a network entity enforces a policy such that the network entity (e.g., which may be a base station or a UPF) intentionally drops packets when the network is not in congestion and does not intentionally drop packets when the network is in congestion.

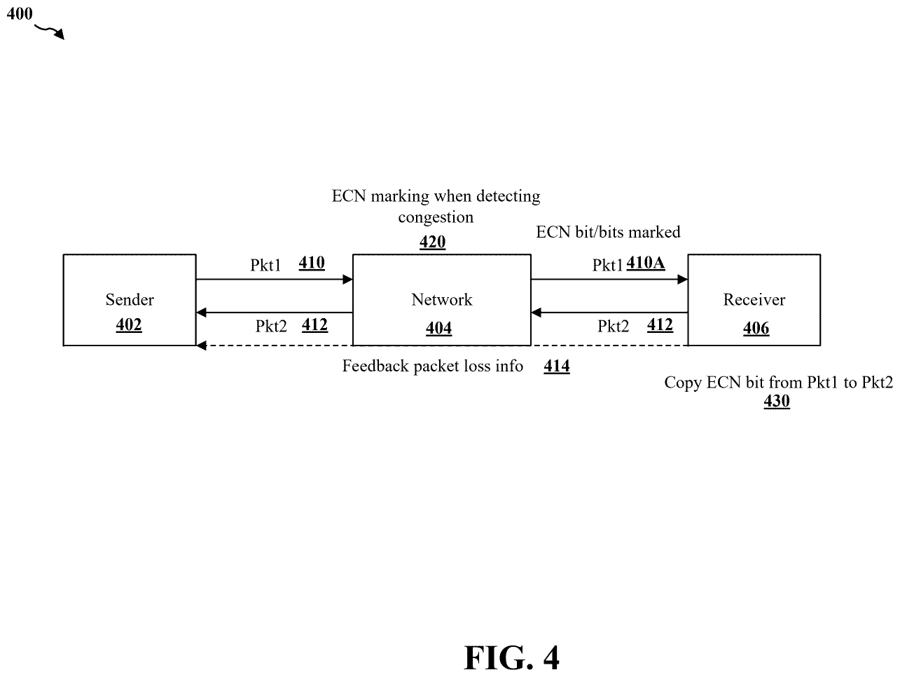

FIG. 4 is a diagram 400 illustrating example communications between an application sender 402, a network entity 404, and an application receiver 406. As illustrated in FIG. 4, the application sender 402 may transmit a first set of packets 410 to the network entity 404, where a recipient of the first set of packets 410 is the application receiver 406. In some aspects, the network entity 404 may intentionally drop one or more packets in the first set of packets 410 when the network entity 404 is not in congestion, or drop one or more packets in the first set of packets 410 when the network entity 404 due to the network entity 404 being in congestion. In some aspects, after dropping one or more packets in the first set of packets 410, at 420, the network entity 404 may mark other packets based on ECN marking and then transmit the marked packets in a set of packets 410A, which corresponds to the first set of packets 410 after dropping and marking. Therefore, upon receiving the set of packets 410A, the application receiver 406 may be aware of whether some packets are dropped based on congestion or dropped based on other reasons. In some aspects, at 430, the application receiver 406 may copy ECN bits from the set of packets 410A to a second set of packets 412 to the network entity 404, where a recipient of the second set of packets 412 is the application sender 402. Upon receiving the second set of packets 412, the network entity 404 may forward the second set of packets 412 to the application sender 402. In some aspects, the application receiver 406 may also feedback packet loss information 414 to the application sender 402.

In some aspects, the network (e.g., network entity 404) may indicate this enforcement, e.g., from policy control function (PCF) to application function (AF) and then to UE where the application sits. In some aspects, such policy may be an assumption that the UE can make. In some aspects, the network (e.g., network entity 404) may assist the application by indicating that whether the network (e.g., network entity 404) is in congestion or not, e.g., by marking or not marking the explicit congestion notification (ECN) bit of the packets. In some aspects, the receiver endpoint may copy the ECN marking bit in the returning packets to the sender endpoint. In some aspects, the network may perform AL-FEC aware PDU Set handling without affecting the congestion control algorithms on the application endpoints. In one example, the network (e.g., network entity 404) discards repair packets rather than, or before (e.g., based on some reason), source packets in the case of FlexFEC without changing the overall packet loss rate, which will not lead to over reduction of the sending rate. In another example, the network (e.g., network entity 404) discards redundant packets (e.g., for MDS and near-MDS codes) across different PDU Sets while still meeting the redundancy ratios for reconstructing the respective ADUs.

In some aspects, the application sender (e.g., application sender 402) may form (e.g., obtain information of) a state of the network (e.g., network entity 404) (e.g., whether the network is in the state of congestion or the state of non-congestion). For example, if x quantity of packets or y % of packets are ECN bit marked in a time window, the network is in state of congestion; otherwise, the network is in the state of non-congestion. The application sender (e.g., application sender 402) may determine whether to take the packet loss rate into account in adjusting the sending rate based on the state. For example, if the network is in the congestion state, the application sender considers the packet loss rate as it would normally do in response to packet losses. If the network is the non-congestion state, the application sender may ignore the observed packet losses. The application sender (e.g., application sender 402) may use the packet loss rate it observed last time when the network (e.g., network entity 404) is in congestion and if the observation was not older by T ms than the current time.

In some aspects, for AL-FEC awareness reporting, the application receiver (e.g., application receiver 406) may send feedback (e.g., packet loss information 414) to the application sender (e.g., application sender 402) based on a variety of different options. In some aspects, in a first option, the application receiver may report the packet loss rate on the source packets without reporting on other packets (i.e., not report the packet loss rate on the repair packets). In some aspects, in a second option, the application receiver (e.g., application receiver 406) may report the packet loss rate on the source packets without reporting on other packets (i.e., not report the packet loss rate on the repair packets) if packet loss rate for the repair packets is above a threshold and (1) the observed source packet loss rate is less than some threshold, or (2) the observed source packet loss rate is less than some threshold and ECN marking is not received. In some aspects, the conditions of the observed source packet loss rate may be less than some threshold or the observed source packet loss rate is less than some threshold and ECN marking is not received may be indications that the network has intentionally dropped repair packets.

In some aspects, the application may send the source packets and the repair packets in two separate streams, e.g., with different IP 5-tuples, or with the same IP 5-tuples but with different synchronization sources (SSRCs). Therefore, if the network (e.g., network entity 404) intentionally drops packets on the repair packet stream without intentionally dropping packets on non-obsolete packets, it is not going to increase the packet loss rate to be reported by the receiver to the sender, and there may be no impact on the congestion control algorithm on the sender endpoint. The network (e.g., the network entity 404) may indicate this behavior, e.g., from PCF to AF and then to receiver (e.g., UE), which then sends the indication to the sender.

In some aspects, in a third option, the application receiver (e.g., application receiver 406) may report the ADU loss rate, and at least one of the packet loss rates on the source packets, the packet loss rate on the repair packets, and ECN marking (by copying the ECN marking in the arrival packets to the departure packets destined back to the sender endpoint).

With the reported ADU loss rate, the sender endpoint (e.g., application sender 402) may know whether the packet losses have caused performance degradation of the ADU level delivery, and that happens if the network (e.g., network entity 404) has dropped non-obsolete packets due to network congestion (and does not intentionally drop non-obsolete packets). If the sender endpoint (e.g., application sender 402) sees ADU loss (e.g., above a threshold), which may be an indication of network congestion, the sender endpoint can reduce the sending rate. Therefore, a congestion control algorithm utilizes both the packet losses and the ADU losses as part of the input for adjusting the sending rate. For example, if the ADU loss rate is negligible (less than a small threshold), even if there is a significant packet loss rate (greater than a big threshold), the congestion control algorithm may not trigger sending rate reduction. Such behavior is correct if the network (e.g., network entity 404) drops obsolete packets when the network intentionally drops packets and does not intentionally drop non-obsolete packets.

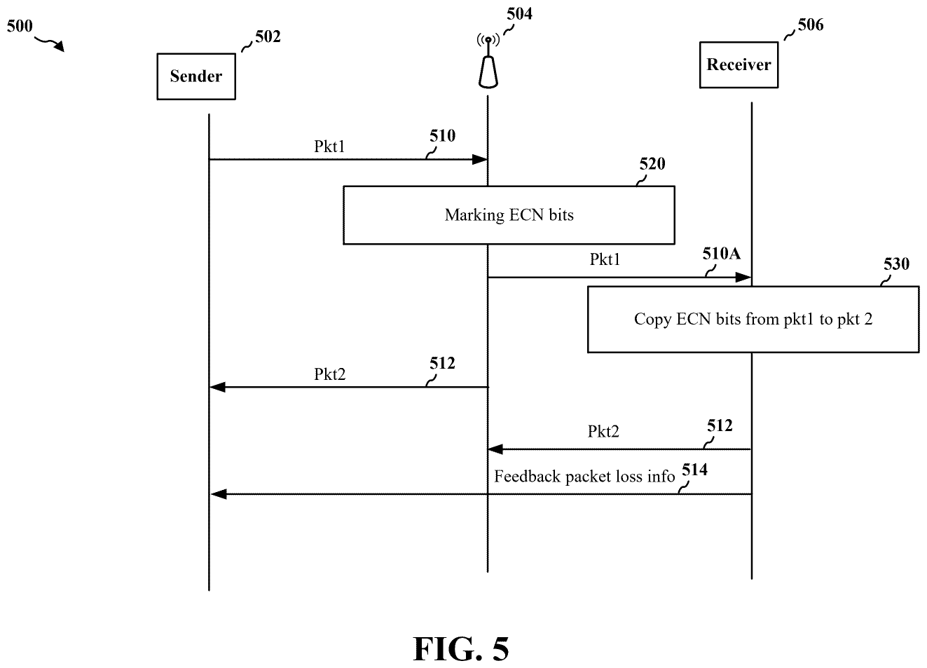

FIG. 5 is a diagram 500 illustrating example a communication flow between an application sender 502, a network entity 504, and an application receiver 506. As illustrated in FIG. 5, the application sender 502 may transmit a first set of packets 510 to the network entity 504, where a recipient of the first set of packets 510 is the application receiver 506. In some aspects, the network entity 504 may intentionally drop one or more packets in the first set of packets 510 when the network entity 504 is not in congestion, or drop one or more packets in the first set of packets 510 when the network entity 504 due to the network entity 504 being in congestion. In some aspects, after dropping one or more packets in the first set of packets 510, at 520, the network entity 504 may mark other packets based on ECN marking and then transmit the marked packets in a set of packets 510A, which corresponds to the first set of packets 510 after dropping and marking. Therefore, upon receiving the set of packets 510A, the application receiver 506 may be aware of whether some packets are dropped based on congestion or dropped based on other reasons. In some aspects, at 530, the application receiver 506 may copy ECN bits from the set of packets 510A to a second set of packets 512 to the network entity 504, where a recipient of the second set of packets 512 is the application sender 502. Upon receiving the second set of packets 512, the network entity 504 may forward the second set of packets 512 to the application sender 502. In some aspects, the application receiver 506 may also feedback packet loss information 514 to the application sender 502.

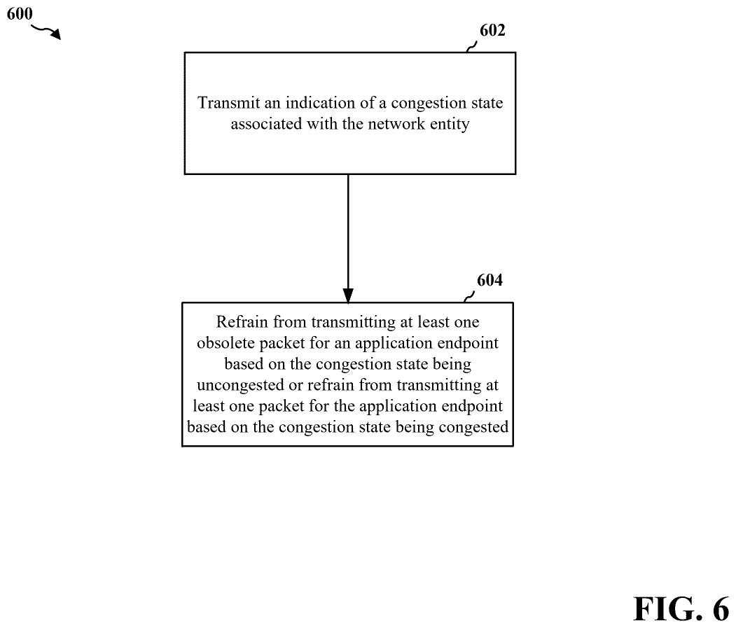

FIG. 6 is a flowchart 600 of a method of wireless communication. The method may be performed by a network entity (e.g., the base station 102, the network entity 404, the network entity 504, the apparatus 1004, the network entity 1102).

At 602, the network entity may transmit an indication of a congestion state associated with the network entity. For example, as shown in FIG. 5, the network entity 504 may transmit an indication of a congestion state associated with the network entity. In some aspects, 602 may be performed by application component 198.

At 604, the network entity may refrain from transmitting at least one obsolete packet for an application endpoint based on the congestion state being uncongested or refrain from transmitting at least one packet for the application endpoint based on the congestion state being congested. For example, the network entity 504 may refrain from transmitting at least one obsolete packet for an application endpoint based on the congestion state being uncongested or refrain from transmitting at least one packet for the application endpoint based on the congestion state being congested. In some aspects, 604 may be performed by application component 198. In some aspects, to refrain from transmitting the at least one obsolete packet based on the congestion state being uncongested, the network entity (e.g., 504) may drop the at least one obsolete packet based on the congestion state being uncongested.

In some aspects, to drop the at least one obsolete packet based on the congestion state being uncongested, the network entity (e.g., 504) may intentionally drop the at least one obsolete packet for the application endpoint based on the congestion state being uncongested. In some aspects, a policy associated with the network entity (e.g., 504) defines that the network entity is allowed to intentionally drop the at least one obsolete packet for the application endpoint based on the congestion state being congested, and where the policy defines that the network entity (e.g., 504) is not allowed to intentionally drop the at least one obsolete packet for the application endpoint when the congestion state is uncongested.

In some aspects, the at least one packet includes a set of obsolete packets or a set of non-obsolete packets, and where to drop the at least one packet, the network entity may drop the at least one packet for the application endpoint due to the network entity being congested. In some aspects, the at least one obsolete packet corresponds to at least one repair packet or at least one obsolete coded packet.

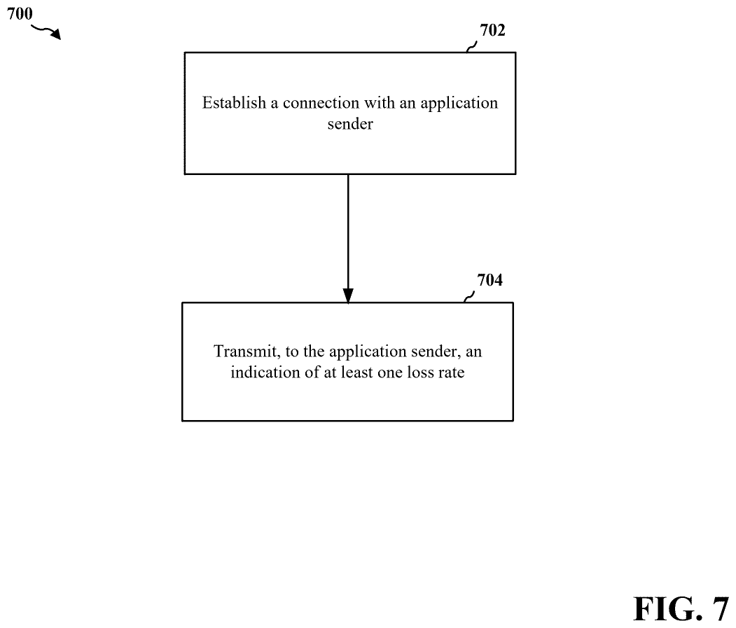

FIG. 7 is a flowchart 700 of a method of wireless communication. The method may be performed by an application receiver (e.g., the UE 104, the base station 102, the application receiver 406, the application receiver 506, the apparatus 1004, the network entity 1102 or a separate entity).

At 702, the application receiver may establish a connection with an application sender. For example, the application receiver 506 may establish a connection with an application sender 502. In some aspects, 702 may be performed by application component 198.

At 704, the application receiver may transmit, to the application sender, an indication of at least one loss rate. In some aspects, 704 may be performed by application component 198. For example, the application receiver 506 may transmit, to the application sender 502, an indication of at least one loss rate.

In some aspects, the application receiver (e.g., 506) may receive, from a network entity (e.g., 504), an indication of a congestion state associated with the network entity. In some aspects, the application receiver may transmit the indication of the at least one loss rate based on the congestion state associated with the network entity.

In some aspects, the at least one loss rate corresponds to a packet loss rate for a set of source packets, and where the packet loss rate is unassociated with a set of repair packets. In some aspects, the at least one loss rate corresponds to a first packet loss rate for a set of source packets based on at least one of: a second packet loss rate for a set of repair packets being above a first threshold, the first packet loss rate being below a second threshold, or the first packet loss rate being below a third threshold and a lack of reception of an explicit congestion notification (ECN). In some aspects, the at least one loss rate includes an application data unit (ADU) loss rate and at least one of: a first packet loss rate for a set of source packets, a second packet loss rate for a set of repair packets, a queuing delay, or a set of explicit congestion notification (ECN) markings associated with the set of source packets or the set of repair packets.

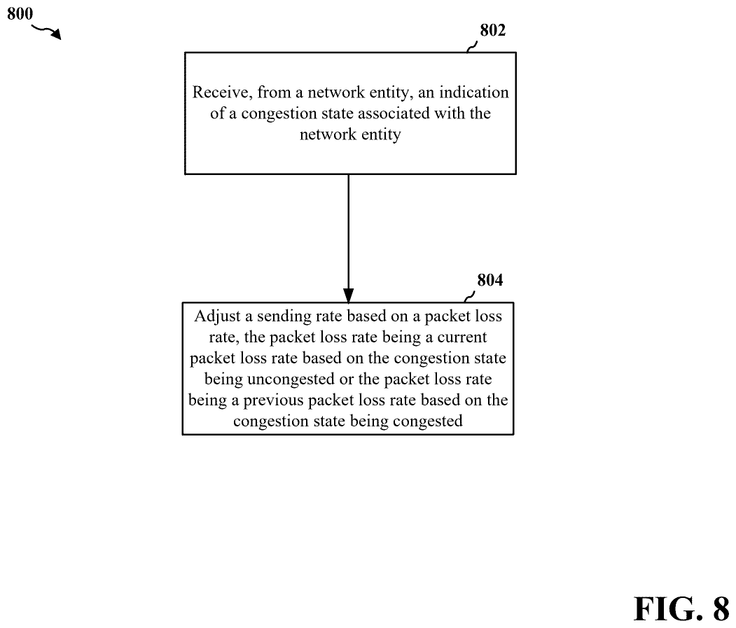

FIG. 8 is a flowchart 800 of a method of wireless communication. The method may be performed by an application sender (e.g., the UE 104, the base station 102, the sender 402, the sender 502, the apparatus 1004, the network entity 1102, or a separate entity).

At 802, the application sender may receive, from a network entity, an indication of a congestion state associated with the network entity. In some aspects, 802 may be performed by application component 198. For example, the application sender 502 may receive, from a network entity 504, an indication of a congestion state associated with the network entity (e.g., based on whether the packet may be ECN masked).

At 804, the application sender may adjust a sending rate based on a packet loss rate, the packet loss rate being a current packet loss rate based on the congestion state being uncongested or the packet loss rate being a previous packet loss rate based on the congestion state being congested. In some aspects, 804 may be performed by application component 198. For example, the application sender 502 may adjust a sending rate based on a packet loss rate, the packet loss rate being a current packet loss rate based on the congestion state being uncongested or the packet loss rate being a previous packet loss rate based on the congestion state being congested.

In some aspects, to adjust the sending rate, the application sender (e.g., 502) may adjust, based on the previous packet loss rate being associated with a timestamp outside a time window, the sending rate based on the current packet loss rate. In some aspects, the application sender (e.g., 502) may output an indication of the adjusted sending rate. In some aspects, to output the indication of the adjusted sending rate, the application sender may transmit the indication of the adjusted sending rate or store the indication of the adjusted sending rate.

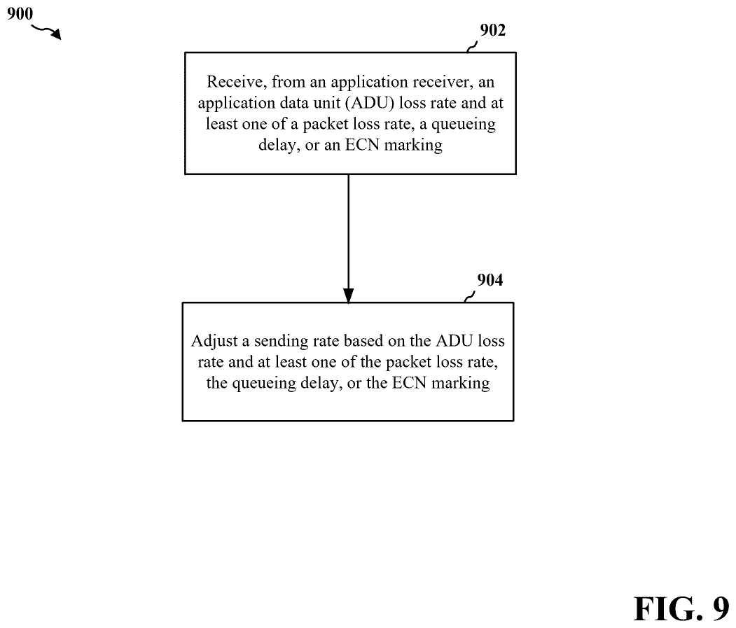

FIG. 9 is a flowchart 900 of a method of wireless communication. The method may be performed by an application sender (e.g., the UE 104, the base station 102, the application sender 402, the application sender 502, the apparatus 1004, the network entity 1102, or a separate entity).

At 902, the application sender may receive, from an application receiver, an application data unit (ADU) loss rate and at least one of a packet loss rate, a queueing delay, or an ECN marking. In some aspects, 902 may be performed by application component 198. For example, the application sender 502 may receive, from an application receiver 506, an application data unit (ADU) loss rate and at least one of a packet loss rate, a queueing delay, or an ECN marking.

At 904, the application sender may adjust a sending rate based on the ADU loss rate and at least one of the packet loss rate, the queueing delay, or the ECN marking. In some aspects, 904 may be performed by application component 198. For example, the application sender 502 may adjust a sending rate based on the ADU loss rate and at least one of the packet loss rate, the queueing delay, or the ECN marking.

In some aspects, to adjust the sending rate, the application sender (e.g., 502) may reduce the sending rate based on the ADU loss rate being above a threshold. In some aspects, to adjust the sending rate, the application sender may refrain from reducing, based on the ADU loss rate being below a threshold, the sending rate. In some aspects, to adjust the sending rate, the application sender may refrain from reducing, based on the ECN marking or the queueing delay, the sending rate. In some aspects, the application sender may output an indication of the adjusted sending rate. In some aspects, to output the indication of the adjusted sending rate, the application sender may transmit the indication of the adjusted sending rate or store the indication of the adjusted sending rate. In some aspects, the network entity may discard one or more repair packets rather than one or more source packets without changing an overall packet loss rate based on the congestion state being congested.

In some aspects, the network entity may discard one or more redundant packets across a set of different protocol data unit (PDU) sets while still meeting at least one redundancy ratio threshold (e.g., at least one particular redundancy ratio as specified or defined) for reconstructing a set of respective ADUs.

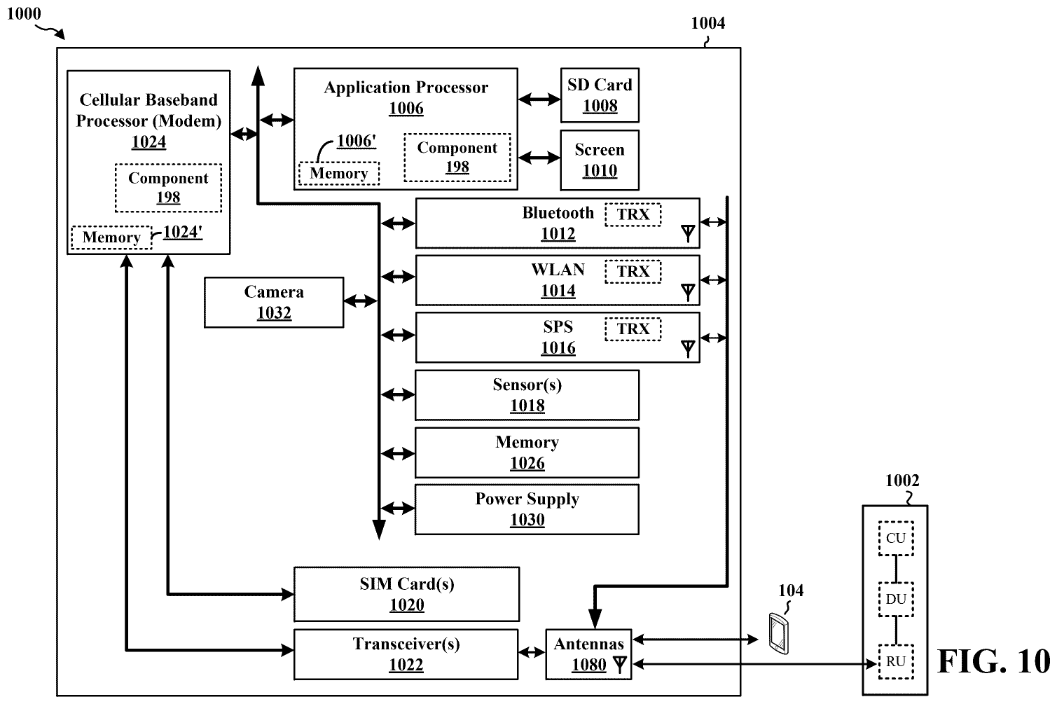

FIG. 10 is a diagram 1000 illustrating an example of a hardware implementation for an apparatus 1004. The apparatus 1004 may be a UE, a component of a UE, or may implement UE functionality. In some aspects, the apparatus 1004 may include at least one cellular baseband processor 1024 (also referred to as a modem) coupled to one or more transceivers 1022 (e.g., cellular RF transceiver). The cellular baseband processor(s) 1024 may include at least one on-chip memory 1024′. In some aspects, the apparatus 1004 may further include one or more subscriber identity modules (SIM) cards 1020 and at least one application processor 1006 coupled to a secure digital (SD) card 1008 and a screen 1010. The application processor(s) 1006 may include on-chip memory 1006′. In some aspects, the apparatus 1004 may further include a Bluetooth module 1012, a WLAN module 1014, an SPS module 1016 (e.g., GNSS module), one or more sensor modules 1018 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1026, a power supply 1030, and/or a camera 1032. The Bluetooth module 1012, the WLAN module 1014, and the SPS module 1016 may include an on-chip transceiver (TRX) (or in some cases, just a receiver (RX)). The Bluetooth module 1012, the WLAN module 1014, and the SPS module 1016 may include their own dedicated antennas and/or utilize the antennas 1080 for communication. The cellular baseband processor(s) 1024 communicates through the transceiver(s) 1022 via one or more antennas 1080 with the UE 104 and/or with an RU associated with a network entity 1002. The cellular baseband processor(s) 1024 and the application processor(s) 1006 may each include a computer-readable medium/memory 1024′, 1006′, respectively. The additional memory modules 1026 may also be considered a computer-readable medium/memory. Each computer-readable medium/memory 1024′, 1006′, 1026 may be non-transitory. The cellular baseband processor(s) 1024 and the application processor(s) 1006 are each responsible for general processing, including the execution of software stored on the computer-readable medium/memory. The software, when executed by the cellular baseband processor(s) 1024/application processor(s) 1006, causes the cellular baseband processor(s) 1024/application processor(s) 1006 to perform the various functions described supra. The computer-readable medium/memory may also be used for storing data that is manipulated by the cellular baseband processor(s) 1024/application processor(s) 1006 when executing software. The cellular baseband processor(s) 1024/application processor(s) 1006 may be a component of the UE 350 and may include the at least one memory 360 and/or at least one of the TX processor 368, the RX processor 356, and the controller/processor 359. In one configuration, the apparatus 1004 may be at least one processor chip (modem and/or application) and include just the cellular baseband processor(s) 1024 and/or the application processor(s) 1006, and in another configuration, the apparatus 1004 may be the entire UE (e.g., see UE 350 of FIG. 3) and include the additional modules of the apparatus 1004.

As discussed supra, the application component 198 may be configured to transmit an indication of a congestion state associated with the network entity. In some aspects, the application component 198 may be further configured to refrain from transmitting at least one obsolete packet for an application endpoint based on the congestion state being uncongested or refrain from transmitting at least one packet for the application endpoint based on the congestion state being congested.

In some aspects, the application component 198 may be configured to establish a connection with an application sender. In some aspects, the application component 198 may be further configured to transmit, to the application sender, an indication of at least one loss rate.

In some aspects, the application component 198 may be configured to receive, from a network entity, an indication of a congestion state associated with the network entity. In some aspects, the application component 198 may be further configured to adjust a sending rate based on a packet loss rate, the packet loss rate being a current packet loss rate based on the congestion state being uncongested or the packet loss rate being a previous packet loss rate based on the congestion state being congested.

In some aspects, the application component 198 may be configured to receive, from an application receiver, an application data unit (ADU) loss rate and at least one of a packet loss rate, a queueing delay, or an ECN marking. In some aspects, the application component 198 may be further configured to adjust a sending rate based on the ADU loss rate and at least one of the packet loss rate, the queueing delay, or the ECN marking. The application component 198 may be within the cellular baseband processor(s) 1024, the application processor(s) 1006, or both the cellular baseband processor(s) 1024 and the application processor(s) 1006. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1004 may include a variety of components configured for various functions. In one configuration, the apparatus 1004, and in particular the cellular baseband processor(s) 1024 and/or the application processor(s) 1006, may include means for transmitting an indication of a congestion state associated with the network entity. In some aspects, the apparatus 1004 may include means for refraining from transmitting at least one obsolete packet for an application endpoint based on the congestion state being uncongested or refrain from transmitting at least one packet for the application endpoint based on the congestion state being congested. In some aspects, the apparatus 1004 may include means for dropping the at least one obsolete packet based on the congestion state being uncongested. In some aspects, the apparatus 1004 may include means for intentionally dropping the at least one obsolete packet for the application endpoint based on the congestion state being uncongested. In some aspects, the apparatus 1004 may include means for dropping the at least one packet for the application endpoint due to the network entity being congested. In some aspects, the apparatus 1004 may include means for establishing a connection with an application sender. In some aspects, the apparatus 1004 may include means for transmitting, to the application sender, an indication of at least one loss rate. In some aspects, the apparatus 1004 may include means for receiving, from a network entity, an indication of a congestion state associated with the network entity. In some aspects, the apparatus 1004 may include means for transmitting the indication of the at least one loss rate based on the congestion state associated with the network entity. In some aspects, the apparatus 1004 may include means for receiving, from a network entity, an indication of a congestion state associated with the network entity. In some aspects, the apparatus 1004 may include means for adjusting a sending rate based on a packet loss rate, the packet loss rate being a current packet loss rate based on the congestion state being uncongested or the packet loss rate being a previous packet loss rate based on the congestion state being congested. In some aspects, the apparatus 1004 may include means for adjusting, based on the previous packet loss rate being associated with a timestamp outside a time window, the sending rate based on the current packet loss rate. In some aspects, the apparatus 1004 may include means for outputting an indication of the adjusted sending rate. In some aspects, the apparatus 1004 may include means for transmitting the indication of the adjusted sending rate. In some aspects, the apparatus 1004 may include means for storing the indication of the adjusted sending rate. In some aspects, the apparatus 1004 may include means for receiving, from an application receiver, an application data unit (ADU) loss rate and at least one of a packet loss rate, a queueing delay, or an ECN marking. In some aspects, the apparatus 1004 may include means for adjusting a sending rate based on the ADU loss rate and at least one of the packet loss rate, the queueing delay, or the ECN marking. In some aspects, the apparatus 1004 may include means for reducing the sending rate based on the ADU loss rate being above a threshold. In some aspects, the apparatus 1004 may include means for refraining from reducing, based on the ADU loss rate being below a threshold, the sending rate. In some aspects, the apparatus 1004 may include means for refraining from reducing, based on the ECN marking or the queueing delay, the sending rate. In some aspects, the apparatus 1004 may include means for outputting an indication of the adjusted sending rate. In some aspects, the apparatus 1004 may include means for transmitting the indication of the adjusted sending rate. The means may be the component 198 of the apparatus 1004 configured to perform the functions recited by the means. As described supra, the apparatus 1004 may include the TX processor 368, the RX processor 356, and the controller/processor 359. As such, in one configuration, the means may be the TX processor 368, the RX processor 356, and/or the controller/processor 359 configured to perform the functions recited by the means.

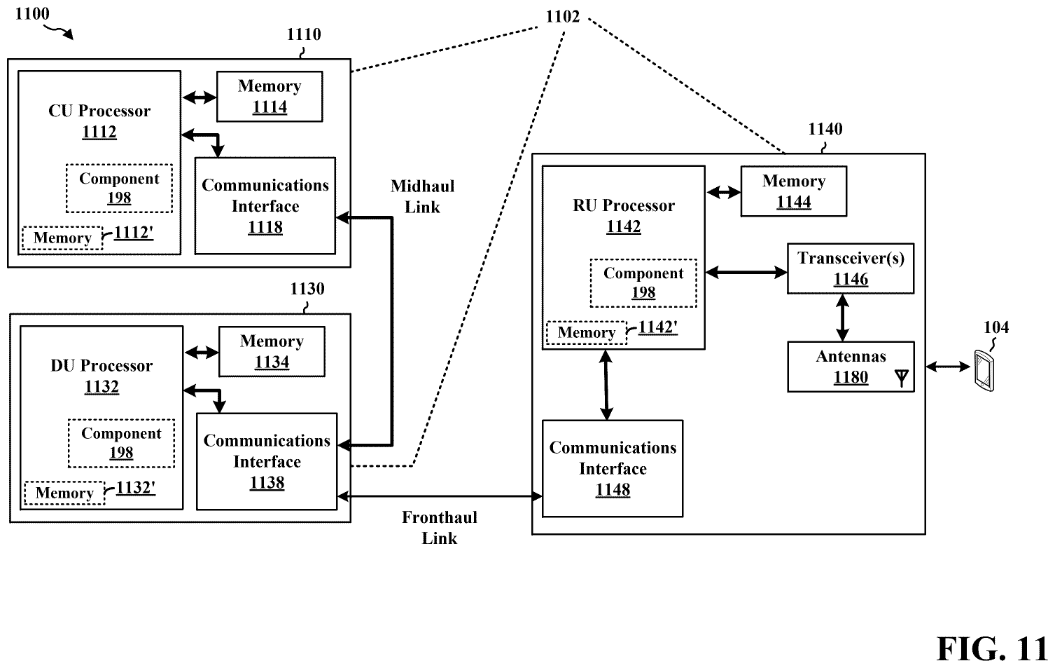

FIG. 11 is a diagram 1100 illustrating an example of a hardware implementation for a network entity 1102. The network entity 1102 may be a BS, a component of a BS, or may implement BS functionality. The network entity 1102 may include at least one of a CU 1110, a DU 1130, or an RU 1140. For example, depending on the layer functionality handled by the component 198, the network entity 1102 may include the CU 1110; both the CU 1110 and the DU 1130; each of the CU 1110, the DU 1130, and the RU 1140; the DU 1130; both the DU 1130 and the RU 1140; or the RU 1140. The CU 1110 may include at least one CU processor 1112. The CU processor(s) 1112 may include on-chip memory 1112′. In some aspects, the CU 1110 may further include additional memory modules 1114 and a communications interface 1118. The CU 1110 communicates with the DU 1130 through a midhaul link, such as an F1 interface. The DU 1130 may include at least one DU processor 1132. The DU processor(s) 1132 may include on-chip memory 1132′. In some aspects, the DU 1130 may further include additional memory modules 1134 and a communications interface 1138. The DU 1130 communicates with the RU 1140 through a fronthaul link. The RU 1140 may include at least one RU processor 1142. The RU processor(s) 1142 may include on-chip memory 1142′. In some aspects, the RU 1140 may further include additional memory modules 1144, one or more transceivers 1146, antennas 1180, and a communications interface 1148. The RU 1140 communicates with the UE 104. The on-chip memory 1112′, 1132′, 1142′ and the additional memory modules 1114, 1134, 1144 may each be considered a computer-readable medium/memory. Each computer-readable medium/memory may be non-transitory. Each of the processors 1112, 1132, 1142 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the application component 198 may be configured to transmit an indication of a congestion state associated with the network entity. In some aspects, the application component 198 may be further configured to refrain from transmitting at least one obsolete packet for an application endpoint based on the congestion state being uncongested or refrain from transmitting at least one packet for the application endpoint based on the congestion state being congested.

In some aspects, the application component 198 may be configured to establish a connection with an application sender. In some aspects, the application component 198 may be further configured to transmit, to the application sender, an indication of at least one loss rate.

In some aspects, the application component 198 may be configured to receive, from a network entity, an indication of a congestion state associated with the network entity. In some aspects, the application component 198 may be further configured to adjust a sending rate based on a packet loss rate, the packet loss rate being a current packet loss rate based on the congestion state being uncongested or the packet loss rate being a previous packet loss rate based on the congestion state being congested.

In some aspects, the application component 198 may be configured to receive, from an application receiver, an application data unit (ADU) loss rate and at least one of a packet loss rate, a queueing delay, or an ECN marking. In some aspects, the application component 198 may be further configured to adjust a sending rate based on the ADU loss rate and at least one of the packet loss rate, the queueing delay, or the ECN marking.

The application component 198 may be within one or more processors of one or more of the CU 1110, DU 1130, and the RU 1140. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1102 may include a variety of components configured for various functions. In one configuration, the network entity 1102 may include means for transmitting an indication of a congestion state associated with the network entity. In some aspects, the network entity 1102 may include means for refraining from transmitting at least one obsolete packet for an application endpoint based on the congestion state being uncongested or refrain from transmitting at least one packet for the application endpoint based on the congestion state being congested. In some aspects, the network entity 1102 may include means for dropping the at least one obsolete packet based on the congestion state being uncongested. In some aspects, the network entity 1102 may include means for intentionally dropping the at least one obsolete packet for the application endpoint based on the congestion state being uncongested. In some aspects, the network entity 1102 may include means for dropping the at least one packet for the application endpoint due to the network entity being congested. In some aspects, the network entity 1102 may include means for establishing a connection with an application sender. In some aspects, the network entity 1102 may include means for transmitting, to the application sender, an indication of at least one loss rate. In some aspects, the network entity 1102 may include means for receiving, from a network entity, an indication of a congestion state associated with the network entity. In some aspects, the network entity 1102 may include means for transmitting the indication of the at least one loss rate based on the congestion state associated with the network entity. In some aspects, the network entity 1102 may include means for receiving, from a network entity, an indication of a congestion state associated with the network entity. In some aspects, the network entity 1102 may include means for adjusting a sending rate based on a packet loss rate, the packet loss rate being a current packet loss rate based on the congestion state being uncongested or the packet loss rate being a previous packet loss rate based on the congestion state being congested. In some aspects, the network entity 1102 may include means for adjusting, based on the previous packet loss rate being associated with a timestamp outside a time window, the sending rate based on the current packet loss rate. In some aspects, the network entity 1102 may include means for outputting an indication of the adjusted sending rate. In some aspects, the network entity 1102 may include means for transmitting the indication of the adjusted sending rate. In some aspects, the network entity 1102 may include means for storing the indication of the adjusted sending rate. In some aspects, the network entity 1102 may include means for receiving, from an application receiver, an application data unit (ADU) loss rate and at least one of a packet loss rate, a queueing delay, or an ECN marking. In some aspects, the network entity 1102 may include means for adjusting a sending rate based on the ADU loss rate and at least one of the packet loss rate, the queueing delay, or the ECN marking. In some aspects, the network entity 1102 may include means for reducing the sending rate based on the ADU loss rate being above a threshold. In some aspects, the network entity 1102 may include means for refraining from reducing, based on the ADU loss rate being below a threshold, the sending rate. In some aspects, the network entity 1102 may include means for refraining from reducing, based on the ECN marking or the queueing delay, the sending rate. In some aspects, the network entity 1102 may include means for outputting an indication of the adjusted sending rate. In some aspects, the network entity 1102 may include means for transmitting the indication of the adjusted sending rate. The means may be the component 198 of the network entity 1102 configured to perform the functions recited by the means. As described supra, the network entity 1102 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. When at least one processor (i.e., a set of one or more processors P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an apparatus for wireless communication at a network entity, including: at least one memory; and at least one processor coupled to the at least one memory, and based at least in part on information stored in the at least one memory, the at least one processor is configured to: transmit an indication of a congestion state associated with the network entity; and refrain from transmitting at least one obsolete packet for an application endpoint based on the congestion state being uncongested or refrain from transmitting at least one packet for the application endpoint based on the congestion state being congested.

Aspect 2 is the apparatus of aspect 1, where to refrain from transmitting the at least one obsolete packet based on the congestion state being uncongested, the at least one processor is configured to: drop the at least one obsolete packet based on the congestion state being uncongested.

Aspect 3 is the apparatus of aspect 2, where to drop the at least one obsolete packet based on the congestion state being uncongested, the at least one processor is configured to: intentionally drop the at least one obsolete packet for the application endpoint based on the congestion state being uncongested.

Aspect 4 is the apparatus of any of aspects 2-3, where a policy associated with the network entity defines that the network entity is allowed to intentionally drop the at least one obsolete packet for the application endpoint based on the congestion state being congested, and where the policy defines that the network entity is not allowed to intentionally drop the at least one obsolete packet for the application endpoint when the congestion state is uncongested.

Aspect 5 is the apparatus of any of aspects 2-4, where the at least one packet comprises a set of obsolete packets or a set of non-obsolete packets, and where to drop the at least one packet, the at least one processor is configured to: drop the at least one packet for the application endpoint due to the network entity being congested.

Aspect 6 is the apparatus of any of aspects 1-5, where the at least one processor is configured to discard one or more repair packets rather than one or more source packets without changing an overall packet loss rate based on the congestion state being congested.

Aspect 7 is the apparatus of any of aspects 1-6, where the at least one processor is configured to discard one or more redundant packets across a set of different protocol data unit (PDU) sets while still meeting at least one redundancy ratio threshold for reconstructing a set of respective ADUs.

Aspect 8 is the apparatus of any of aspects 1-7, where the at least one obsolete packet corresponds to at least one repair packet or at least one obsolete coded packet.

Aspect 9 is an apparatus for wireless communication at an application receiver, including: at least one memory; and at least one processor coupled to the at least one memory, and based at least in part on information stored in the at least one memory, the at least one processor is configured to: establish a connection with an application sender; and transmit, to the application sender, an indication of at least one loss rate.

Aspect 10 is the apparatus of aspect 9, where the at least one processor is further configured to: receive, from a network entity, an indication of a congestion state associated with the network entity; and transmit the indication of the at least one loss rate based on the congestion state associated with the network entity.

Aspect 11 is the apparatus of any of aspects 9-10, where the at least one loss rate corresponds to a packet loss rate for a set of source packets, and where the packet loss rate is unassociated with a set of repair packets.

Aspect 12 is the apparatus of any of aspects 9-11, where the at least one loss rate corresponds to a first packet loss rate for a set of source packets based on at least one of: a second packet loss rate for a set of repair packets being above a first threshold, the first packet loss rate being below a second threshold, or the first packet loss rate being below a third threshold and a lack of reception of an explicit congestion notification (ECN).

Aspect 13 is the apparatus of any of aspects 9-12, where the at least one loss rate comprises an application data unit (ADU) loss rate and at least one of: a first packet loss rate for a set of source packets, a second packet loss rate for a set of repair packets, a queuing delay, or a set of explicit congestion notification (ECN) markings associated with the set of source packets or the set of repair packets.

Aspect 14 is an apparatus for wireless communication at an application sender, including: at least one memory; and at least one processor coupled to the at least one memory, and based at least in part on information stored in the at least one memory, the at least one processor is configured to: receive, from a network entity, an indication of a congestion state associated with the network entity; and adjust a sending rate based on a packet loss rate, the packet loss rate being a current packet loss rate based on the congestion state being uncongested or the packet loss rate being a previous packet loss rate based on the congestion state being congested.

Aspect 15 is the apparatus of aspect 14, where to adjust the sending rate, the at least one processor is configured to: adjust, based on the previous packet loss rate being associated with a timestamp outside a time window, the sending rate based on the current packet loss rate.

Aspect 16 is the apparatus of any of aspects 14-15, where the at least one processor is further configured to: output an indication of the adjusted sending rate.

Aspect 17 is the apparatus of aspect 16, where to output the indication of the adjusted sending rate, the at least one processor is configured to: transmit the indication of the adjusted sending rate; or store the indication of the adjusted sending rate.

Aspect 18 is an apparatus for wireless communication at an application sender, including: at least one memory; and at least one processor coupled to the at least one memory, and based at least in part on information stored in the at least one memory, the at least one processor is configured to: receive, from an application receiver, an application data unit (ADU) loss rate and at least one of a packet loss rate, a queueing delay, or an ECN marking; and adjust a sending rate based on the ADU loss rate and at least one of the packet loss rate, the queueing delay, or the ECN marking.

Aspect 19 is the apparatus of aspect 18, where to adjust the sending rate, the at least one processor is configured to: reduce the sending rate based on the ADU loss rate being above a threshold.

Aspect 20 is the apparatus of any of aspects 18-19, where to adjust the sending rate, the at least one processor is configured to: refrain from reducing, based on the ADU loss rate being below a threshold, the sending rate.

Aspect 21 is the apparatus of any of aspects 18-20, where to adjust the sending rate, the at least one processor is configured to: refrain from reducing, based on the ECN marking or the queueing delay, the sending rate.

Aspect 22 is the apparatus of any of aspects 18-21, where the at least one processor is further configured to: output an indication of the adjusted sending rate.

Aspect 23 is the apparatus of aspect 22, where to output the indication of the adjusted sending rate, the at least one processor is configured to: transmit the indication of the adjusted sending rate; or store the indication of the adjusted sending rate.

Aspect 24 is a method of wireless communication for implementing any of aspects 1 to 23.

Aspect 25 is a computer-readable medium (e.g., a non-transitory computer-readable medium) storing computer executable code, the code when executed by at least one processor causes the at least one processor to implement any of aspects 1 to 23.

Aspect 26 is an apparatus comprising means for implementing any of aspects 1 to 23.

What is claimed is:

1. An apparatus for wireless communication at a network entity, including:
at least one memory; and
at least one processor coupled to the at least one memory, and based at least in part on information stored in the at least one memory, the at least one processor is configured to:
transmit an indication of a congestion state associated with the network entity; and
refrain from transmitting at least one obsolete packet for an application endpoint based on the congestion state being uncongested or refrain from transmitting at least one packet for the application endpoint based on the congestion state being congested.

2. The apparatus of claim 1, wherein to refrain from transmitting the at least one obsolete packet based on the congestion state being uncongested, the at least one processor is configured to:
drop the at least one obsolete packet based on the congestion state being uncongested.

3. The apparatus of claim 2, wherein to drop the at least one obsolete packet based on the congestion state being uncongested, the at least one processor is configured to:
intentionally drop the at least one obsolete packet for the application endpoint based on the congestion state being uncongested.

4. The apparatus of claim 2, wherein a policy associated with the network entity defines that the network entity is allowed to intentionally drop the at least one obsolete packet for the application endpoint based on the congestion state being congested, and wherein the policy defines that the network entity is not allowed to intentionally drop the at least one obsolete packet for the application endpoint when the congestion state is uncongested.

5. The apparatus of claim 2, wherein the at least one packet comprises a set of obsolete packets or a set of non-obsolete packets, and wherein to drop the at least one packet, the at least one processor is configured to:
drop the at least one packet for the application endpoint due to the network entity being congested.

6. The apparatus of claim 1, wherein the at least one processor is configured to discard one or more repair packets rather than one or more source packets without changing an overall packet loss rate based on the congestion state being congested.

7. The apparatus of claim 1, wherein the at least one processor is configured to discard one or more redundant packets across a set of different protocol data unit (PDU) sets while still meeting at least one redundancy ratio threshold for reconstructing a set of respective ADUs.

8. The apparatus of claim 1, wherein the at least one obsolete packet corresponds to at least one repair packet or at least one obsolete coded packet.

9. An apparatus for wireless communication at an application receiver, including:
at least one memory; and
at least one processor coupled to the at least one memory, and based at least in part on information stored in the at least one memory, the at least one processor is configured to:
establish a connection with an application sender; and
transmit, to the application sender, an indication of at least one loss rate.

10. The apparatus of claim 9, wherein the at least one processor is further configured to:
receive, from a network entity, an indication of a congestion state associated with the network entity; and
transmit the indication of the at least one loss rate based on the congestion state associated with the network entity.

11. The apparatus of claim 9, wherein the at least one loss rate corresponds to a packet loss rate for a set of source packets, and wherein the packet loss rate is unassociated with a set of repair packets.

12. The apparatus of claim 9, wherein the at least one loss rate corresponds to a first packet loss rate for a set of source packets based on at least one of: a second packet loss rate for a set of repair packets being above a first threshold, the first packet loss rate being below a second threshold, or the first packet loss rate being below a third threshold and a lack of reception of an explicit congestion notification (ECN).

13. The apparatus of claim 9, wherein the at least one loss rate comprises an application data unit (ADU) loss rate and at least one of: a first packet loss rate for a set of source packets, a second packet loss rate for a set of repair packets, a queuing delay, or a set of explicit congestion notification (ECN) markings associated with the set of source packets or the set of repair packets.

14. An apparatus for wireless communication at an application sender, including:
at least one memory; and
at least one processor coupled to the at least one memory, and based at least in part on information stored in the at least one memory, the at least one processor is configured to:
receive, from a network entity, an indication of a congestion state associated with the network entity; and
adjust a sending rate based on a packet loss rate, the packet loss rate being a current packet loss rate based on the congestion state being uncongested or the packet loss rate being a previous packet loss rate based on the congestion state being congested.

15. The apparatus of claim 14, wherein to adjust the sending rate, the at least one processor is configured to:
adjust, based on the previous packet loss rate being associated with a timestamp outside a time window, the sending rate based on the current packet loss rate.

16. The apparatus of claim 14, wherein the at least one processor is further configured to:
output an indication of the adjusted sending rate.

17. The apparatus of claim 16, wherein to output the indication of the adjusted sending rate, the at least one processor is configured to:
transmit the indication of the adjusted sending rate; or
store the indication of the adjusted sending rate.

18. The apparatus of claim 14, wherein to adjust the sending rate, the at least one processor is configured to:
refrain from reducing, based on an ECN marking or a queueing delay, the sending rate.

19. The apparatus of claim 14, wherein to adjust the sending rate, the at least one processor is configured to:
adjust a sending rate based on an application data unit (ADU) loss rate, a queueing delay, or an ECN marking.

20. The apparatus of claim 19, wherein to adjust the sending rate, the at least one processor is configured to:
reduce the sending rate based on the ADU loss rate being above a threshold.
